(19) United States
(12) Patent Application Publication
(10) Pub. No.: US 2026/0161030 A1
(43) Pub. Date: Jun. 11, 2026

(54) METHOD OF FORMING SPACER BUMPS

(71) Applicant: INDUSTRIAL TECHNOLOGY RESEARCH INSTITUTE, Hsinchu (TW)

(72) Inventors: Li-Ching WANG, Zhudong Township (TW); Kuan-Wei CHEN, Zhudong Township (TW)

(73) Assignee: INDUSTRIAL TECHNOLOGY RESEARCH INSTITUTE, Hsinchu (TW)

(21) Appl. No.: 19/016,996

(22) Filed: Jan. 10, 2025

(30) Foreign Application Priority Data
Dec. 6, 2024 (CN) 202411786857.0

(51) Int. Cl. G02F 1/1339; G02F 1/1335; G02F 1/1337

(52) U.S. Cl. CPC G02F 1/13398; G02F 1/133512; G02F 1/133788

(57) ABSTRACT

A method of forming spacer bumps includes providing a substrate, and the substrate has an alignment film thereon. A metal mold is disposed on the alignment film, and the metal mold includes a plurality of holes penetrating through it. A photo curable material is filled into the holes of the metal mold, and the photo curable material is pre-cured using UV radiation. The metal mold is removed, and then the photo curable material is secondary-cured using UV radiation to form a plurality of spacer bumps. The material of the alignment film is different from the material of the spacer bumps.

### CROSS REFERENCE TO RELATED APPLICATIONS

The present application is based on, and claims priority from, China Application Serial Number 202411786857.0, filed on Dec. 6, 2024, the disclosure of which is hereby incorporated by reference herein in its entirety.

### TECHNICAL FIELD

The technical field relates to a method of forming spacer bumps.

### BACKGROUND

Because the industry is pursuing ever-higher resolution in displays, the size of each single pixel continues to shrink. Traditional liquid-crystal display panels such as super-twisted nematic (STN) liquid-crystal displays have gradually been replaced by thin film transistor liquid-crystal displays (TFT-LCD). The properties of traditional space control materials no longer meet product needs. Traditional space control materials are micro-level spherical particles that are evenly distributed in the LCD panel area, and an encapsulating adhesive is then used to enclose the peripheral of the LCD panel. However, it is difficult to evenly distribute the spherical particles due to the spherical particles tend to aggregate easily, so that the space between two pieces of ITO glass in the display cannot be completely maintained. In addition, due to the geometric characteristics of the spherical particles, they shift easily to leak light and reduce the display quality. Photo curable space control material is made of photosensitive polymers, and designed such that specific areas can be exposed to produce a photo-curing adhesive material that can efficiently maintain the space between two pieces of ITO glass and prevent light leakage, thereby greatly improving the display effect.

Most of the photo curable space control materials currently on the market are spin-coated on a substrate, and then exposed and developed to be shaped. Although the above method may form products with high stability, its steps are complicated and time-consuming. Moreover, the process such as spin coating and development will generate a lot of waste adhesive materials, increasing costs and carbon emissions.

Accordingly, a novel method for forming spacer bumps is called for to address the above issue.

### SUMMARY

One embodiment of the disclosure provides a method of forming spacer bumps. The method includes providing a substrate. There is an alignment film disposed on the substrate. The method includes disposing a metal mold on the alignment film. There is a plurality of holes penetrating through the metal mold. The method includes filling a photo curable material into the holes of the metal mold, and pre-curing the photo curable material using UV radiation. The method includes removing the metal mold. The method includes secondary-curing the photo curable material using UV radiation after removing the metal mold to form a plurality of spacer bumps. The material of the alignment film is different from the material of the spacer bumps.

In some embodiments, each of the holes includes an upper opening coplanar with a top surface of the metal mold and a lower opening coplanar with a bottom surface of the metal mold. The upper opening has a first size. The lower opening has a second size. The first size and the second size have a ratio of 80:100 to 90:100.

In some embodiments, the substrate includes an array substrate, a color filter substrate, or a color filter on array (COA) substrate.

In some embodiments, the UV radiation for pre-curing the photo curable material and the UV radiation for secondary-curing the photo curable material have an energy density ratio of 1:2 to 1:4.

In some embodiments, the UV radiation for pre-curing the photo curable material has an energy density of 200 mJ/cm² to 300 mJ/cm².

In some embodiments, the step of filling the photo curable material into the holes of the metal mold is performed by inkjet printing.

In some embodiments, the photo curable material includes a photo initiator and a monomer, and the photo initiator and the monomer have a weight ratio of 0.2:100 to 2:100.

In some embodiments, the photo initiator includes radical photo initiator, cationic photo initiator, or a combination thereof.

In some embodiments, the spacer bumps have a height of 4 micrometers to 10 micrometers.

In some embodiments, the spacer bumps have a hardness of 0.3 GPa to 0.55 GPa.

In some embodiments, the step of filling the photo curable material and the step of pre-curing the photo curable material with the UV radiation are performed simultaneously.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 is a diagram of disposing a metal mold on an alignment overlying a substrate in some embodiments of the disclosure.

FIG. 2 shows a top view of the metal mold.

FIG. 3 is a diagram of the holes in some embodiments of the disclosure.

FIG. 4 is a diagram of filling a photo curable material into the holes of the metal mold and pre-curing the photo curable material in some embodiments of the disclosure.

FIG. 5 is a diagram of removing the metal mold in some embodiments of the disclosure.

FIG. 6 is a diagram of secondary-curing the photo curable material to form spacer bumps in some embodiments of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

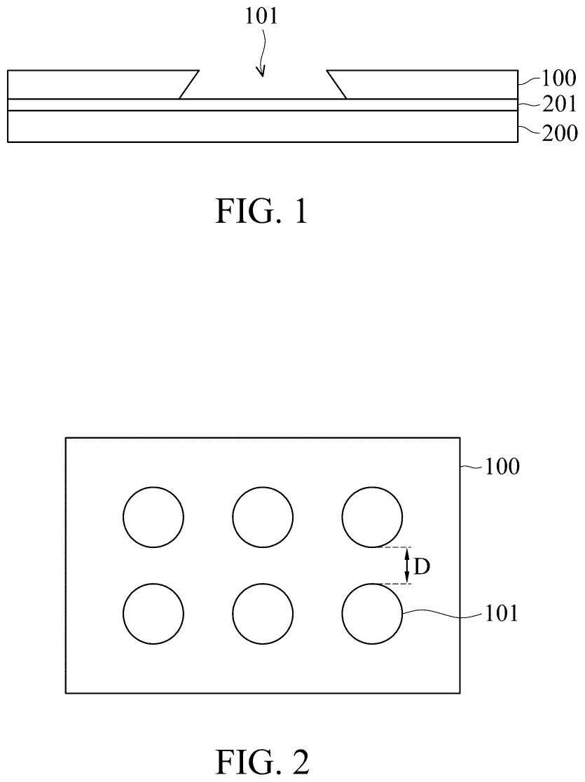

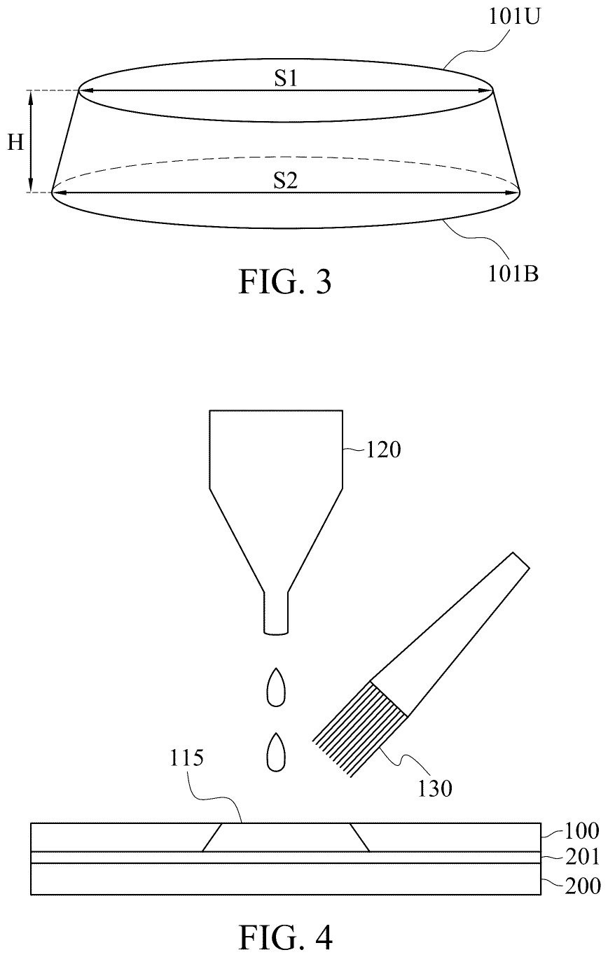

One embodiment of the disclosure provides a method of forming spacer bumps, In some embodiments, the method includes providing a substrate 200, and the substrate 200 has an alignment film 201 thereon, as shown in FIG. 1. A metal mold 100 is disposed on the alignment film 201, and the metal mold 100 includes a plurality of holes 101 penetrating the metal mold 100, as shown in FIG. 2. As shown in FIG. 3, the holes 101 are cylinder with a narrow top and a wide bottom. Each of the holes 101 includes an upper opening 101U coplanar with a top surface of the metal mold 100 and a lower opening 101B coplanar with a bottom surface of the metal mold 100. It should be understood that the number and the shape of the holes 101 in FIGS. 2 and 3 are only for illustration, and the disclosure is not limited thereto. For example, the number of the holes 101 can be greater than or less than 6 depending on the design requirements. On the other hand, the top view shape of the holes 101 is not limited to circle, which can be polygon (such as triangle, square, rectangle, hexagon, or another polygon), oval, or another suitable shape. Regardless of the top view shape, the upper opening 101U of the hole 101 has a first size S1, the lower opening 101B of the opening 101 has a second size S2, and the first size S1 and the second size S2 have a ratio of 80:100 to 90:100. If the upper opening 101U is too large, it may be difficult to remove the metal mold 100 in the following step. If the upper opening 101U is too small, it may be difficult to fill a photo curable material into the hole 101, thereby generating bubbles remained in the spacer bump.

In some embodiments, the substrate 200 includes an array substrate, a color filter substrate, or a color filter on array substrate. It should be understood that the active elements (e.g. transistors of the array substrate or of the COA substrate) and/or the passive elements (e.g. color filters) are disposed between the base material (not labeled) of the substrate 200 and the alignment film 201. The base material can be made of glass, plastic, metal, semiconductor, or another suitable material.

As shown in FIG. 4, a photo curable material 115 is then filled into the holes 101 of the metal mold 100, and then pre-cured using UV radiation 130. In some embodiments, an inkjet printing device 120 can be used to inkjet print the photo curable material 115 into the holes 101. This method is advantageous due to that the photo curable material 115 only fills the holes 101 and is not formed on the top surface of the metal mold 100, thereby saving the amount of the photo curable material 115 to reduce the cost. Compared to the method of forming the spacer bumps of the photo curable material by lithography, the cost of the metal mold 100 is lower than a photomask. In addition, the photo curable material other than the spacer bumps will be removed (e.g., developed) in the lithography process for the photo curable material, and it is difficult to reuse the removed photo curable material. In other words, the method of forming the spacer bumps through the metal mold may dramatically reduce the amount of the photo curable material to reduce the cost.

In some embodiments, the photo curable material 115 includes photo initiator and a monomer, and the photo initiator and the monomer have a weight ratio of 0.2:100 to 2:100. If the amount of the photo initiator is too low, the pre-cured photo curable material 115 cannot be shaped and will collapse after removing the metal mold 100. If the amount of the photo initiator is too high, the crosslinked molecular segment will be too short, and the material will be too hard and brittle and lack of toughness of elastic recovery. In some embodiments, the photo initiator includes radical photo initiator, cationic photo initiator, or a combination thereof. In some embodiments, the monomer can be a common acrylate monomer.

In some embodiments, the UV radiation 130 for pre-curing the photo curable material 115 has an energy density of 200 mJ/cm² to 300 mJ/cm². If the energy density of the UV radiation 130 is too low, the photo curable material 115 cannot be shaped and will collapse after removing the metal mold 100. If the energy density of the UV radiation 130 is too high, the photo curable material 115 may be completely cured to adhere to the metal mold 100. As such, a part of the cured photo curable material is possibly remained on the metal mold 100 during removing the metal mold 100, such that the final spacer bumps will be broken. In addition, it should be understood that the step of filling the photo curable material 115 into the holes and the step of pre-curing the photo curable material 115 can be simultaneously or non-simultaneously performed. If the steps are performed simultaneously (not pre-curing the photo curable material 115 after filling the photo curable material 115 into the holes 101), the photo curable material 115 will be pre-cured when the photo-curable material 115 is filled into the holes 101 (e.g., the photo curable material 115 is dropwise filled into the holes 101). As such, the problem of different pre-curing degrees of the photo curable material 115 at different parts (e.g., bottom and top) of the holes 101 can be prevented. On the other hand, the pre-curing period is the period of filling the photo curable material 115 into the hole 101, which may save the process time.

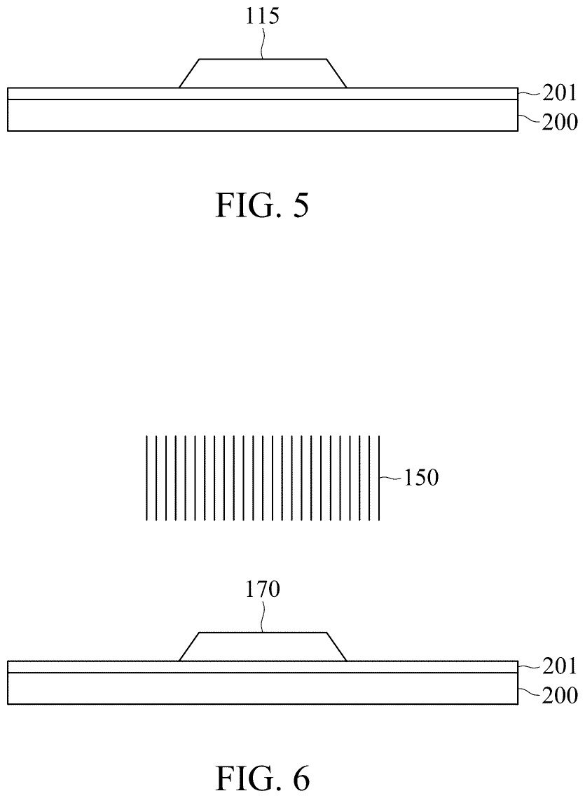

As shown in FIG. 5, the metal mold 100 is then removed to remain the pre-cured photo curable material 115 on the alignment film 201. While the photo curable material 115 is pre-cured, it will not collapse as a liquid. In addition, the pre-cured photo curable material 115 will not adhere to the surface of the metal mold 100 to break the spacer bumps. In some embodiments, the metal mold 100 is magnetic, and the metal mold 100 can be removed by magnetic attraction. While the pre-cured photo curable material 115 does not adhere to the surface of the metal mold 100, there is no need to form an additional release film between the metal film 100 and the photo curable material 115.

As shown in FIG. 6, the photo curable material 115 is then secondary-cured using UV radiation 150 after removing the metal mold 100, thereby forming a plurality of spacer bumps 170. It should be understood that the alignment film 201 can be made of polyimide (PI), which is different from the material for the spacer bumps 170 (e.g., a cured photo curable material). As such, materials can be selected based on the required properties of the alignment film 201 (e.g., having Young's modulus of greater than 3 GPa) and the required properties of the spacer bumps 170 (e.g. having Young's modulus of greater than 4.5 GPa) without compromising each other.

In some embodiments, the UV radiation 130 for pre-curing the photo curable material 115 and the UV radiation 150 for secondary-curing the photo curable material 115 have an energy density ratio of 1:2 to 1:4. If the energy density of the UV radiation 150 is too low, the hardness of the spacer bumps 170 will be too low, and the spacer bumps will easily deform in subsequent application to degrade the performance of the device. If the energy density of the UV radiation 150 is too high, it will consume too much energy and the spacer bumps 170 tend to be brittle.

In some embodiments, the spacer bumps have a height of 4 micrometers to 10 micrometers. In some embodiments, the spacer bumps 170 has a hardness of 0.3 GPa to 0.55 GPa. Spacer bumps formed of a photo curable material and a general lithography have a height of less than 4 micrometers, otherwise they are easy to collapse. The method of the disclosure may form the spacer bumps 170 having a higher height. As such, the spacer bumps 170 are formed on the substrate 200. In some embodiments, the substrate can be assembled with another substrate, liquid crystal materials can be filled into a space (e.g., gap) between the substrate and the other substrate, and then sealed to complete the so-called liquid-crystal display.

Accordingly, the method of the disclosure may form the spacer bumps 170 without a photomask. In addition, the amount of the photo curable material 115 can be saved by the method of the disclosure to reduce the cost.

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

In following Examples, the metal mold 100 included six holes 101 penetrating the metal mold 100, as shown in FIG. 2. The metal mold 100 was made of magnetic stainless steel or nickel alloy. Each of the holes 101 was a cylinder with a narrow top and a wide bottom, as shown in FIG. 3. The upper opening 101U of the hole 101 was coplanar with the top surface of the metal mold 100. The upper opening 101U was circular, and its first size S1 such as diameter was 20 micrometers. The lower opening 101B of the hole 101 was coplanar with the bottom surface of the metal mold 100. The lower opening 101B was circular, and its second size S2 such as diameter was 24 micrometers. The holes 101 had a height H (i.e., the thickness of the metal mold 100) of 5 micrometers. The two adjacent holes 101 had a distance D therebetween of 4 micrometers.

### Example 1

50 parts by weight of acrylate monomer TMPTA, 50 parts by weight of acrylate monomer PETA, 20 parts by weight of aliphatic polyurethane acrylate (Doublemer 584 commercially available from Double Bond Chemical Ind., Co., Ltd, dissolved in HDDA, concentration=12 wt %), 0.8 parts by weight of radical photo initiator 184 (commercially available from MUFONG INTERNATIONAL CO., LTD.), and 0.4 parts by weight of radical photo initiator 819 (commercially available from MUFONG INTERNATIONAL CO., LTD.) were mixed to form a photo curable material UV-1. The chemical structure of TMPTA is shown below:

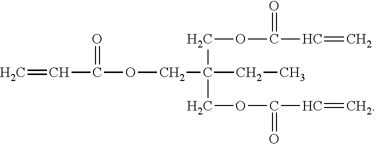 [SMILES: C=CC(=O)OCC(CC)(COC(=O)C=C)COC(=O)C=C]

The chemical structure of PETA is shown below:

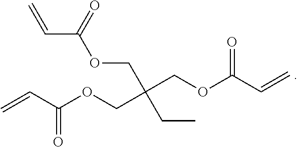 [SMILES: C=CC(=O)OCC(CC)(COC(=O)C=C)COC(=O)C=C]

The chemical structure of HDDA is shown below:

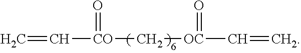

The chemical structure of the radical photo initiator 184 is shown below:

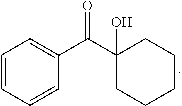 [SMILES: O=C(c1ccccc1)C1(O)CCCCC1]

The chemical structure of the radical photo initiator 819 is shown below:

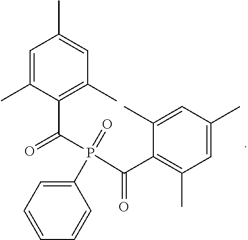

The metal mold was disposed on a PI alignment film (having a thickness of 100 micrometers and a Young's modulus of 4.2 GPa, taken from Industrial Technology Research Institute, Material and Chemical Laboratories) overlying a glass substrate, and the metal mold was closely contact with the PI alignment film. Six drops of the photo curable material UV-1 were inkjet-printed into each of the holes of the metal mold to fill the holes, and the inkjet-printed photo curable material UV-1 was simultaneously pre-cured using UV radiation of low energy density (250 mJ/cm²) to be shaped. Subsequently, the metal mold was removed, and the pre-cured photo curable material was exposed to UV radiation of high energy density (900 mJ/cm²) for 2 seconds to be completely cured to form spacer bumps. The spacer bumps were analyzed by Nano indenter to measure their hardness (0.53 GPa) and Young's modulus (7.1 GPa). The shape of the spacer bumps inherited the shape of the holes, e.g., a cylinder with a narrow top and a wide bottom. Each of the spacer bumps had an upper shape of circle with a diameter of 20 micrometers, a lower shape of circle with a diameter of 22.5 micrometers, and a height of 4.75 micrometers.

### Example 2

The metal mold was disposed on a PI alignment film (having a thickness of 100 micrometers and a Young's modulus of 4.2 GPa, taken from Industrial Technology Research Institute, Material and Chemical Laboratories) overlying a glass substrate, and the metal mold was closely contact with the PI alignment film. Six drops of the photo curable material UV-1 were inkjet-printed into each of the holes of the metal mold to fill the holes, and the inkjet-printed photo curable material UV-1 was simultaneously pre-cured using UV radiation of low energy density (250 mJ/cm²) to be shaped. Subsequently, the metal mold was removed, and the pre-cured photo curable material was exposed to UV radiation of high energy density (500 mJ/cm²) for 3 seconds to be completely cured to form spacer bumps. The spacer bumps were analyzed by Nano indenter to measure their hardness (0.35 GPa) and Young's modulus (6.1 GPa). The shape of the spacer bumps inherited the shape of the holes, e.g., a cylinder with a narrow top and a wide bottom. Each of the spacer bumps had an upper shape of circle with a diameter of 20 micrometers, a lower shape of circle with a diameter of 22.5 micrometers, and a height of 4.71 micrometers.

### Example 3

50 parts by weight of acrylate monomer TMPTA, 50 parts by weight of acrylate monomer PETA, 20 parts by weight of aliphatic polyurethane acrylate (Doublemer 584), 0.4 parts by weight of radical photo initiator 184, and 0.2 parts by weight of radical photo initiator 819 were mixed to form a photo curable material UV-2.

The metal mold was disposed on a PI alignment film (having a thickness of 100 micrometers and a Young's modulus of 4.2 GPa, taken from Industrial Technology Research Institute, Material and Chemical Laboratories) overlying a glass substrate, and the metal mold was closely contact with the PI alignment film. Six drops of the photo curable material UV-2 were inkjet-printed into each of the holes of the metal mold to fill the holes, and the inkjet-printed photo curable material UV-2 was simultaneously pre-cured using UV radiation of low energy density (250 mJ/cm²) to be shaped. Subsequently, the metal mold was removed, and the pre-cured photo curable material was exposed to UV radiation of high energy density (900 mJ/cm²) for 3 seconds to be completely cured to form spacer bumps. The spacer bumps were analyzed by Nano indenter to measure their hardness (0.43 GPa) and Young's modulus (6.4 GPa). The shape of the spacer bumps inherited the shape of the holes, e.g., a cylinder with a narrow top and a wide bottom. Each of the spacer bumps had an upper shape of circle with a diameter of 20 micrometers, a lower shape of circle with a diameter of 22.5 micrometers, and a height of 4.77 micrometers.

### Comparative Example 1

Six drops of the photo curable material UV-1 were directly inkjet-printed onto a PI film overlying a glass substrate, and the inkjet-printed photo curable material UV-1 was simultaneously pre-cured using UV radiation of low energy density (250 mJ/cm²). Subsequently, the pre-cured photo curable material was exposed to UV radiation of high energy density (900 mJ/cm²) for 2 seconds to be completely cured. The cured photo curable material had a flat circle shape with a height of 4 micrometers and a lateral size of 135 micrometers.

### Comparative Example 2

The metal mold was disposed on a PI alignment film (having a thickness of 100 micrometers and a Young's modulus of 4.2 GPa, taken from Industrial Technology Research Institute, Material and Chemical Laboratories) overlying a glass substrate, and the metal mold was closely contact with the PI alignment film. Six drops of the photo curable material UV-1 were inkjet-printed into each of the holes of the metal mold to fill the holes, and the inkjet-printed photo curable material UV-1 was simultaneously pre-cured using UV radiation of low energy density (250 mJ/cm²) to be shaped. Subsequently, the metal mold was removed, and the pre-cured photo curable material was exposed to UV radiation of high energy density (350 mJ/cm²) for 4 seconds to be completely cured to form spacer bumps. The spacer bumps were analyzed by Nano indenter to measure their hardness (0.21 GPa) and Young's modulus (5.0 GPa). The shape of the spacer bumps inherited the shape of the holes, e.g., a cylinder with a narrow top and a wide bottom. Each of the spacer bumps had an upper shape of circle with a diameter of 20.1 micrometers, a lower shape of circle with a diameter of 22.7 micrometers, and a height of 4.4 micrometers.

### Comparative Example 3

50 parts by weight of acrylate monomer TMPTA, 50 parts by weight of acrylate monomer PETA, 20 parts by weight of aliphatic polyurethane acrylate (Doublemer 584), 0.1 parts by weight of radical photo initiator 184, and 0.05 parts by weight of radical photo initiator 819 were mixed to form a photo curable material UV-3.

The metal mold was disposed on a PI alignment film (having a thickness of 100 micrometers and a Young's modulus of 4.2 GPa, taken from Industrial Technology Research Institute, Material and Chemical Laboratories) overlying a glass substrate, and the metal mold was closely contact with the PI alignment film. Six drops of the photo curable material UV-3 were inkjet-printed into each of the holes of the metal mold to fill the holes, and the inkjet-printed photo curable material UV-3 was simultaneously pre-cured using UV radiation of low energy density (250 mJ/cm²) to be shaped. However, the radical photo initiator amount in the photo curable material UV-3 was too low to shape the pre-cured photo curable material. After the metal mold was removed, the pre-cured photo curable material collapsed and could not be further cured to form spacer bumps.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A method of forming spacer bumps, comprising:
providing a substrate, wherein the substrate has an alignment film thereon;
disposing a metal mold on the alignment film, wherein the metal mold comprises a plurality of holes penetrating therethrough;
filling a photo curable material into the holes of the metal mold, and pre-curing the photo curable material using UV radiation;
removing the metal mold; and
secondary-curing the photo curable material using UV radiation after removing the metal mold to form a plurality of spacer bumps,
wherein a material of the alignment film is different from a material of the spacer bumps.

2. The method as claimed in claim 1, wherein each of the holes comprises an upper opening coplanar with a top surface of the metal mold and a lower opening coplanar with a bottom surface of the metal mold, wherein the upper opening has a first size, the lower opening has a second size, and the first size and the second size have a ratio of 80:100 to 90:100.

3. The method as claimed in claim 1, wherein the substrate comprises an array substrate, a color filter substrate, or a color filter on array substrate.

4. The method as claimed in claim 1, wherein the UV radiation for pre-curing the photo curable material and the UV radiation for secondary-curing the photo curable material have an energy density ratio of 1:2 to 1:4.

5. The method as claimed in claim 1, wherein the UV radiation for pre-curing the photo curable material has an energy density of 200 mJ/cm² to 300 mJ/cm².

6. The method as claimed in claim 1, wherein the step of filling the photo curable material into the holes of the metal mold is performed by inkjet printing.

7. The method as claimed in claim 1, wherein the photo curable material comprises a photo initiator and a monomer, and the photo initiator and the monomer have a weight ratio of 0.2:100 to 2:100.

8. The method as claimed in claim 1, wherein the photo initiator comprises radical photo initiator, cationic photo initiator, or a combination thereof.

9. The method as claimed in claim 1, wherein the spacer bumps have a height of 4 micrometers to 10 micrometers.

10. The method as claimed in claim 1, wherein the spacer bumps have a hardness of 0.3 GPa to 0.55 GPa.

11. The method as claimed in claim 1, wherein the step of filling the photo curable material and the step of pre-curing the photo curable material using the UV radiation are performed simultaneously.
